(19) United States
(12) Patent Application Publication
(10) Pub. No.: US 2006/0050645 A1
(43) Pub. Date: Mar. 9, 2006

(54) Packet validity checking in switched fabric networks

(76) Inventors: Christopher L. Chappell, Chandler, AZ (US); James Mitchell, Chandler, AZ (US)

Correspondence Address: FISH & RICHARDSON, PC, P.O. BOX 1022, MINNEAPOLIS, MN, 55440-1022, US

(21) Appl. No.: 10/934,639

(22) Filed: Sep. 3, 2004

(51) Int. Cl. H04L 12/26

(52) U.S. Cl. 370/252

(57) ABSTRACT

Methods and apparatus, including computer program products, implementing techniques for receiving a node configuration packet that includes a request for access to a memory space of an Advanced Switching device, performing a set of checks on a header of the received node configuration packet to determine whether the packet is valid, and processing the access request when the packet is determined to be valid.

### BACKGROUND

This invention relates to packet validity checking in switched fabric networks.

PCI (Peripheral Component Interconnect) Express is a serialized I/O interconnect standard developed to meet the increasing bandwidth needs of the next generation of computer systems. PCI Express was designed to be fully compatible with the widely used PCI local bus standard. PCI is beginning to hit the limits of its capabilities, and while extensions to the PCI standard have been developed to support higher bandwidths and faster clock speeds, these extensions may be insufficient to meet the rapidly increasing bandwidth demands of PCs in the near future. With its high-speed and scalable serial architecture, PCI Express may be an attractive option for use with or as a possible replacement for PCI in computer systems. The PCI Special Interest Group (PCI-SIG) manages PCI specifications as open industry standards, and provides the specifications to its members.

Advanced Switching (AS) is a technology which is based on the PCI Express architecture, and which enables standardization of various backplane architectures. AS utilizes a packet-based transaction layer protocol that operates over the PCI Express physical and data link layers. The AS architecture provides a number of features common to multi-host, peer-to-peer communication devices such as blade servers, clusters, storage arrays, telecom routers, and switches. These features include support for flexible topologies, packet routing, congestion management (e.g., credit-based flow control), fabric redundancy, and fail-over mechanisms. The Advanced Switching Interconnect Special Interest Group (ASI-SIG) is a collaborative trade organization chartered with providing a switching fabric interconnect standard, specifications of which it provides to its members.

### BRIEF DESCRIPTION OF THE DRAWINGS

FIG. 1 is a block diagram of a switched fabric network.

FIG. 2 is a diagram of protocol stacks.

FIG. 3 is a diagram of an AS transaction layer packet (TLP) format.

FIG. 4 is a diagram of an AS route header format.

FIG. 5 is a diagram of an AS device with a PI-4 unit.

FIG. 6 is a diagram of a PI-4 packet format.

### DETAILED DESCRIPTION

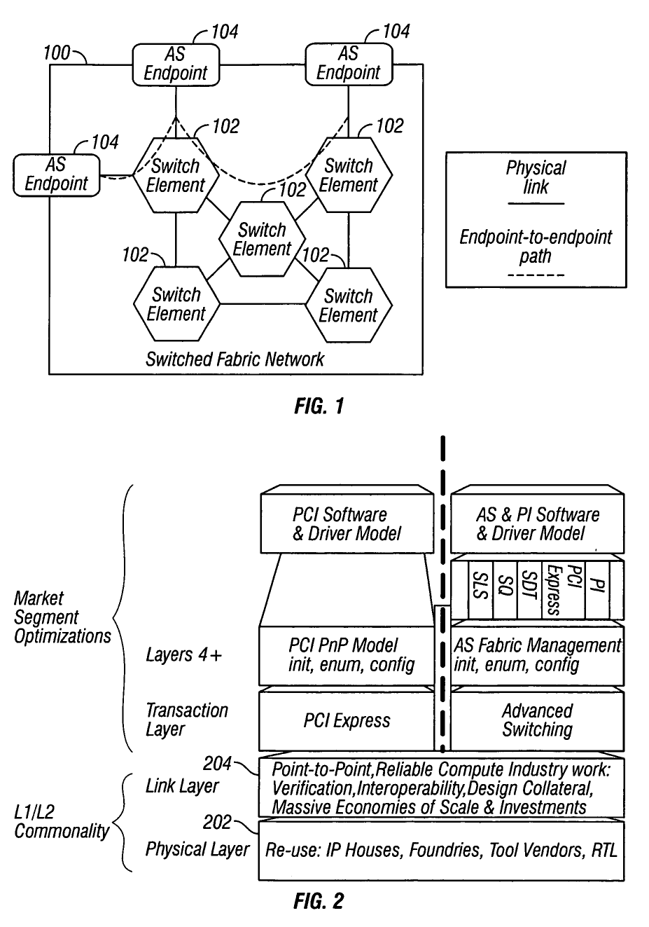

FIG. 1 shows a switched fabric network 100. The network 100 may include switch elements 102 and end points 104, e.g., CPU chipsets, network processors, digital signal processors, media access and host adaptors. The switch elements 102 constitute internal nodes of the network 100 and provide interconnects with other switch elements 102 and end points 104. The end points 104 reside on the edge of the switch fabric and represent data ingress and egress points for the switch fabric. The end points 104 may encapsulate and/or translate packets entering and exiting the switch fabric and may be viewed as “bridges” between the switch fabric and other interfaces (not shown).

Each switch element 102 and end point 104 has an Advanced Switching (AS) interface that is part of the AS architecture defined by the “Advance Switching Core Architecture Specification” (available from the Advanced Switching Interconnect-SIG at www.asi-sig.com). The AS architecture utilizes a packet-based transaction layer protocol that operates over the PCI Express physical and data link layers 202, 204, as shown in FIG. 2.

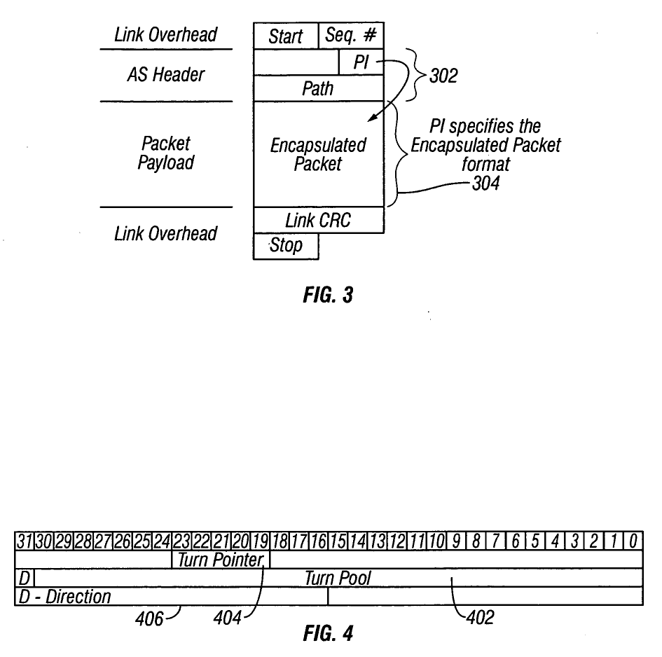

AS uses a path-defined routing methodology in which the source of a packet provides all information required by a switch (or switches) to route the packet to the desired destination. FIG. 3 shows an AS transaction layer packet (TLP) format 300. The packet includes an AS route header 302 and an encapsulated packet payload 304. The AS route header 302 contains the information that is necessary to route the packet through an AS fabric (i.e., “the path”), and a field that specifies the Protocol Interface (PI) of the encapsulated packet. AS switches route packets using the information contained in the route header 302 without necessarily requiring interpretation of the contents of the encapsulated packet 304.

A path may be defined by the turn pool 402, turn pointer 404, and direction flag 406 in the AS route header 302, as shown in FIG. 4. A packet's turn pointer indicates the position of the switch's “turn value” within the turn pool. When a packet is received, the switch may extract the packet's turn value using the turn pointer, the direction flag, and the switch's turn value bit width. The extracted turn value for the switch may then used to calculate the egress port.

The PI field in the AS route header 302 determines the format of the encapsulated packet 304. The PI field is inserted by the end point 104 that originates the AS packet and is used by the end point that terminates the packet to correctly interpret the packet contents. The separation of routing information from the remainder of the packet enables an AS fabric to tunnel packets of any protocol.

PIs represent fabric management and application-level interfaces to the switched fabric network 100. Table 1 provides a list of PIs currently supported by the AS Specification.

TABLE 1
AS protocol encapsulation interfaces

| PI number | Protocol Encapsulation Identity (PEI) |
|---|---|
| 0 | Fabric Discovery |
| 1 | Multicasting |
| 2 | Congestion Management |
| 3 | Segmentation and Reassembly |
| 4 | Node Configuration Management |
| 5 | Fabric Event Notification |
| 6 | Reserved |
| 7 | Reserved |
| 8 | PCI-Express |
| 9-223 | ASI-SIG defined PEIs |
| 224-254 | Vendor-defined PEIs |
| 255 | Invalid |

PIs 0-7 are used for various fabric management tasks, and PIs 8-254 are application-level interfaces. As shown in Table 1, PI-8 is used to tunnel or encapsulate a native PCI Express packet. Other PIs may be used to tunnel various other protocols, e.g., Ethernet, Fibre Channel, ATM (Asynchronous Transfer Mode), InfiniBand®, and SLS (Simple Load Store). An advantage of an AS switch fabric is that a mixture of protocols may be simultaneously tunneled through a single, universal switch fabric making it a powerful and desirable feature for next generation modular applications such as media gateways, broadband access routers, and blade servers.

The AS architecture supports the establishment of direct endpoint-to-endpoint logical paths through the switch fabric known as Virtual Channels (VCs). This enables a single switched fabric network to service multiple, independent logical interconnects simultaneously, each VC interconnecting AS end points for control, management and data. Each VC provides its own queue so that blocking in one VC does not cause blocking in another. Each VC may have independent packet ordering requirements, and therefore each VC can be scheduled without dependencies on the other VCs.

The AS architecture defines three VC types: Bypass Capable Unicast (BVC); Ordered-Only Unicast (OVC); and Multicast (MVC). BVCs have bypass capability, which may be necessary for deadlock free tunneling of some, typically load/store, protocols. OVCs are single queue unicast VCs, which are suitable for message oriented “push” traffic. MVCs are single queue VCs for multicast “push” traffic.

The AS architecture provides a number of congestion management techniques, one of which is a credit-based flow control technique that ensures that packets are not lost due to congestion. Link partners (e.g., an end point 104 and a switch element 102) in the network exchange flow control credit information to guarantee that the receiving end of a link has the capacity to accept packets. Flow control credits are computed on a VC-basis by the receiving end of the link and communicated to the transmitting end of the link. Typically, packets are transmitted only when there are enough credits available for a particular VC to carry the packet. Upon sending a packet, the transmitting end of the link debits its available credit account by an amount of flow control credits that reflects the packet size. As the receiving end of the link processes (e.g., forwards to an end point 104) the received packet, space is made available on the corresponding VC and flow control credits are returned to the transmission end of the link. The transmission end of the link then adds the flow control credits to its credit account.

The AS architecture supports the implementation of an AS Configuration Space in each AS device (e.g., AS end point 104) in the network. The AS Configuration Space is a storage area that includes fields to specify device characteristics as well as fields used to control the AS device. The AS Configuration Space includes up to 16 apertures where configuration information can be stored. Each aperture includes up to 4 Gbytes of storage and is 32-bit addressable. The configuration information is presented in the form of capability structures and other storage structures, such as tables and a set of registers. Table 2 provides a set of capability structures (“AS Native Capability Structures”) that are defined by the AS Specification and stored in aperture 0 of the AS Configuration Space.

TABLE 2
AS Native Capability Structures

| | End | Switch |
|---|---|---|
| AS Native Capability Structure | points | Elements |
| Baseline Device | R | R |
| Spanning Tree | R | R |
| Spanning Tree Election | O | N/A |
| Switch Spanning Tree | N/A | R |
| Device PI | O | O |
| Scratchpad | R | R |
| Doorbell | O | O |
| Multicast Routing Table | N/A | O |
| Semaphore | R | R |
| AS Event | R | R |
| AS Event Spooling | O | N/A |
| AS Common Resource | O | N/A |
| Power Management | O | N/A |
| Virtual Channels | R w/OE | R w/OE |
| Configuration Space Permission | R | R |
| End point Injection Rate Limit | O | N/A |
| Status Based Flow Control | O | O |
| Minimum Bandwidth Scheduler | N/A | O |
| Drop Packet | O | O |
| Statistics Counters | O | O |
| SAR | O | N/A |
| Integrated Devices | O | N/A |

Legend:
O = Optional normative
R = Required
R w/OE = Required with optional normative elements
N/A = Not applicable

The information stored in the AS Native Capability Structures can be accessed through node configuration packets, e.g., PI-4 packets, which are used for device management.

In one implementation of a switched fabric network, the AS devices on the network are restricted to read-only access of another AS device's AS Native Capability Structures, with the exception of one or more AS end points that have been elected as fabric managers.

A fabric manager election process may be initiated by a variety of either hardware or software mechanisms to elect one or more fabric managers for the switched fabric network. A fabric manager is an AS end point that “owns” all of the AS devices, including itself, in the network. If multiple fabric managers, e.g., a primary fabric manager and a secondary fabric manager, are elected, then each fabric manager may own a subset of the AS devices in the network. Alternatively, the secondary fabric manager may declare ownership of the AS devices in the network upon a failure of the primary fabric manager, e.g., resulting from a fabric redundancy and fail-over mechanism.

Once a fabric manager declares ownership, it has privileged access to its AS devices' AS Native Capability Structures. In other words, the fabric manager has read and write access to the AS Native Capability Structures of all of the AS devices in the network.

As previously discussed, the AS Native Capability Structures of an AS device are accessible through PI-4 packets. Accordingly, each AS device in the switched fabric network can be implemented to include an AS PI-4 unit for processing PI-4 packets received through the network from a fabric manager or another AS device. In the examples to follow, the term “local AS device” refers to an AS device that has received a PI-4 packet and is processing the PI-4 packet, and the term “remote AS device” refers to an AS device, e.g., a fabric manager or another AS device, on the network that is attempting to access the local AS device's AS Native Capability Structures.

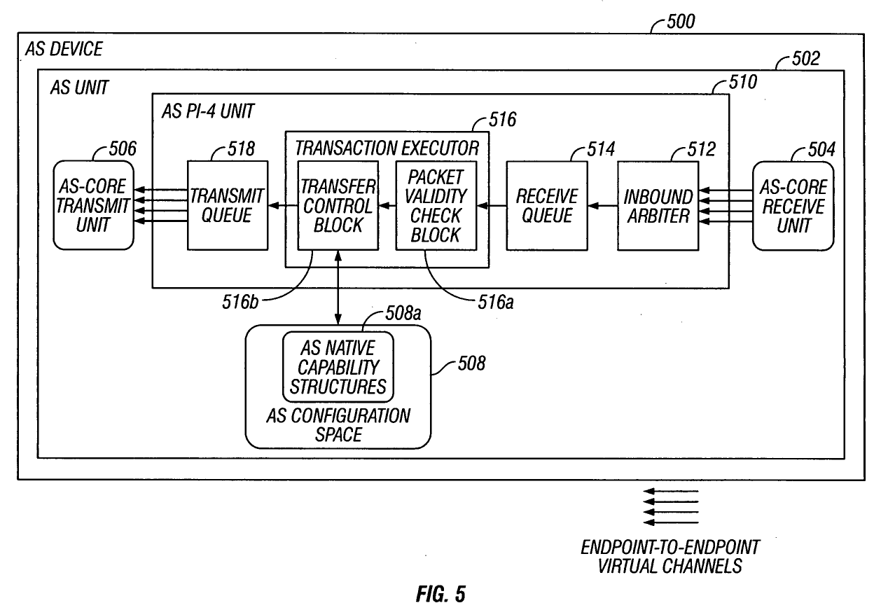

Referring to FIG. 5, the local AS device 500 includes an AS unit 502 that implements the AS transaction layer operating over the physical and data link layers. In one example, the AS unit 502 includes an AS-Core receive unit 504, an AS-Core transmit unit 506, an AS Configuration Space 508, and a PI-4 unit 510 for processing PI-4 packets received at the AS device 500. The AS Configuration Space 508 includes one or more AS Native Capability Structures 508a.

PI-4 packets received at the local AS device 500 are passed from the physical and data link layers to the PI-4 unit 510 for processing through the AS-Core receive unit 504. In one implementation, an inbound arbiter 512 in the PI-4 unit 510 arbitrates access between multiple VCs in the AS-Core receive unit 504 and a single receive queue 514 in round-robin fashion. The receive queue 514 provides buffer space for incoming PI-4 packets so that the PI-4 packets can be removed from the VCs in the AS-Core receive unit 504 as quickly as possible. There is an inherent latency involved in accessing the AS device's AS Configuration Space 508. Having the receive queue 514 in the PI-4 unit 510 shields this latency from the AS-Core receive unit 504, thus allowing flow control credits to be made available quickly to remote AS devices.

The receive queue 514 can be implemented as a first-in-first-out (FIFO) structure that passes PI-4 packets to a transaction executor 516 in the order it receives them. The receive queue 514 is sufficiently wide to enable the transaction executor 516 to simultaneously examine all of the fields of an incoming PI-4 packet's header in a single clock cycle prior to processing the PI-4 packet.

As shown in FIG. 5, the transaction executor 516 has a packet validity check block 516a and a transfer control block 516b. For each incoming PI-4 packet, the packet validity check block 516a performs a set of checks on header fields (“header fields under test”) of the PI-4 packet by comparing the value provided in the header fields under test with corresponding expected values. A successful comparison of each header value in the PI-4 packet with the expected header value indicates that the PI-4 packet is valid and can be presented to the transfer control block 516b for processing. However, if one or more of the header values in the PI-4 packet does not match its expected value, then a failure has occurred, and the packet validity check block 516a notifies the transfer control block 516b that the PI-4 packet is to be handled as an exception.

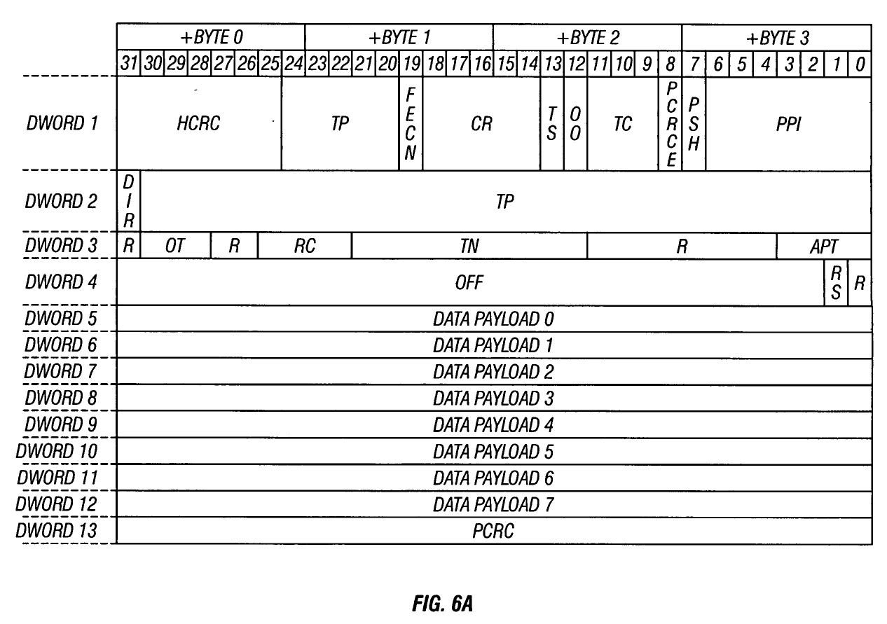

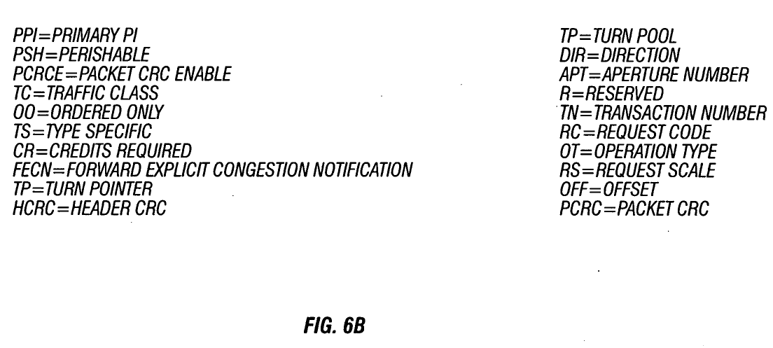

The header fields under test may include all or a subset of the header fields of a PI-4 packet having the format shown in FIG. 6. In one implementation, the packet validity check block 516a performs the set of checks on the header fields under test concurrently in a single clock cycle. In another implementation, in one clock cycle, the packet validity check block 516a determines a packet type of an incoming PI-4 packet by examining the AS route header Direction (DIR) flag and the PI-4 Header Operation Type (OT) field. Table 3 shows how a packet is identified using these fields.

TABLE 3
PI-4 packet types

| PI-4 Packet Type | Direction Flag | Operation Type |
|---|---|---|
| Write | 0 | 000 |
| Read Request | 0 | 100 |
| Read Completion with Data | 1 | 101 |
| Read Completion with Error | 1 | 111 |

In the following clock cycle, the packet validity check block 516a performs the set of checks on the header fields under test concurrently.

The expected header values can be pre-loaded into the packet validity check block 516a. In one implementation, for each header field under test, a single expected header value is provided with the expectation that all incoming PI-4 packets contain a header value that should match the expected header value. However, in other implementations, multiple expected header values can be stored in the packet validity check block 516a for each header field, with one of the multiple expected header values selected to perform the comparison with the header value in a received PI-4 packet. The selection may be made based on packet type. For example, if an incoming PI-4 packet is determined to be a read request packet, the packet validity check block 516a uses one set of expected header values. If an incoming PI-4 packet is determined to be a write packet, a different set of expected header values are used.

In the following description, the check performed on each header field under test is described on a field-by-field basis with reference to the PI-4 packet format of FIG. 6. Where only one expected value is stored in the packet validity check block 516a, a single example is provided. Where multiple expected values are stored for a particular header field, multiple examples are discussed with reference to a particular packet type.

FIG. 6 shows a PI-4 packet having 4 double words, also referred to as dwords (each dword has 32 bits of data) of header data (i.e., dwords 1-4) followed by up to 8 dwords of payload data (i.e., dwords 5-12) and optionally, one dword of packet cyclic redundancy check (PCRC) (i.e., dword 13).

The least significant 7 bits of dword 1 contains a Primary Protocol Interface (PPI) field. For PI-4 packets, the PPI field must contain the value “4”. If the PPI field contains any other value, the PPI field check fails and the packet validity check block 516a automatically discards the incoming packet.

Bit 8 of dword 1 contains the Packet CRC Enable (PCRCE) field. The PCRCE flag indicates whether a dword of PCRC has been appended to the packet's payload (e.g., dword 13) or the end Qf the PI-header if no payload is included (e.g., dword 5). If bit 8 is set, the packet validity check block 516a calculates a 32-bit cyclic redundancy code value over dwords 3-12 and checks the resulting value against the value provided in the PCRC field in dword 13. If the two values match, the PCRCE field check passes. If not, the PCRCE field check fails and the PI-4 packet is discarded.

The Ordered Only (OO) field is in bit 12 of dword 1. For PI-4 packets, the OO flag must be set to 0, otherwise the OO field check fails.

The Type Specific (TS) field is in bit 13 of dword 1. For PI-4 read request packets, this bit must be set to 1. For PI-4 write packets and PI-4 read completion packets, this bit must be set to 0, otherwise the TS field check fails.

Bits 25 to 31 contain the Header CRC (HCRC) field. The source of a PI-4 packet is required to generate a header cyclic redundancy check value using the first two dwords of the PI-4 packet and store the value in the HCRC field prior to transmitting the PI-4 packet on the AS fabric. The packet validity check block 516a calculates the HCRC value using a polynomial defined in the AS Core specification, and compares the calculated HCRC value against the value provided in the incoming PI-4 packet's HCRC field. If the two values match, the HCRC field check passes, otherwise the HCRC field check fails.

Bits 0 to 30 of dword 2 contain the Turn Pool (TP) field. The TP value provided in the incoming PI-4 packet is checked against the forward routed turn pool values of the primary and secondary fabric managers. The forward routed turn pool value for each fabric manager is provided in the spanning tree capability structure 508a stored in aperture 0 of the AS Configuration Space 508. The TP value is also checked against the forward routed turn pool value of each AS device that is permitted to access the AS Configuration Space 508. If the TP value provided in the incoming PI-4 packet matches a forward routed turn pool value stored in the spanning tree capability structure 508a, this indicates to the packet validity check block that the incoming PI-4 packet originated from a remote AS device that is permitted some form of access to the AS Configuration Space 508.

The least significant four bits of dword 3 contain the Aperture Number (APT) field. The APT field is used in performing Configuration Space Permissions (CSP) checks. The AS Configuration Space 508 includes up to 16 apertures and is implemented with an access protection mechanism that is applied on a per aperture basis using a Configuration Space Permission structure 508a. Each configuration space aperture can be programmed to allow either read or write access, or both, from one, some or all of the remote devices through the setting of particular bits of the Configuration Space Permission structure 508a. The value provided in the APT field indicates the AS Configuration Space aperture that contains the location (“target aperture”) to be read from or written to. The packet validity check block 516a performs a lookup operation of the Configuration Space Permission structure 508a to determine the access permissions for the target aperture. The APT field check passes only if the access permissions for the target aperture correspond with the packet type of the incoming PI-4 packet.

Bits 22-25 contain the Request Code (RC) field. For a PI-4 write packets, the RC field's value provides the payload packet length in dwords. The packet validity check block 516a converts the 4-bit binary value to its decimal form and determines the (requested) payload packet length of the PI-4 packet according to the following:

| | |
|---|---|
| 0-7: | illegal |
| 8: | 8 dwords |
| 9: | 7 dwords |
| 10: | 6 dwords |
| 11: | 5 dwords |
| 12: | 4 dwords |
| 13: | 3 dwords |
| 14: | 2 dwords |
| 15: | 1 dword |

As the PI-4 write packet is being received, the packet validity check block 516a counts the number of dwords that form the payload. If the AS device 500 supports block writes to the AS Configuration Space 508, larger payloads of up to a maximum of 8 dwords can be written, and the Block Write Supported bit in the Device Control and Status register of the Baseline Device Capability structure 508a must be set to 1. The detected packet length is compared against the packet length specified by the RC field. If the two values match, the RC field check passes, otherwise, the RC field check fails and the PI-4 write packet is discarded. If the Block Write Supported bit is set to 0, any value in the RC field other than 15 is illegal, and the PI-4 write packet is discarded.

In the case of a PI-4 read request packet, if the Request Scale (RS) field in dword 4 is set to 1 and the PI-4 unit supports single dword reads, then the RC field's value must also be 1, otherwise the RC field check fails. If the PI-4 unit supports block reads, the RC field's value provides the number of dwords to be read, and the PI-4 unit 510 must be able to return up to 8 dwords of requested data in a single PI-4 read completion packet. If the RC field's value provides an unsupported number (i.e., a request for more than 8 dowrds of data), the RC field check fails and the transfer control block 516b is notified of a malformed packet event.

Bits 2 to 31 of dword 4 contain the Offset (OFF) field. The OFF field's value is used to generate the address within the specified aperture of the AS Configuration Space 508 that is being accessed for a read or write operation. If the Block Write Supported bit or the Block Read Supported bit in the Device Control and Status register of the Baseline Device Capability structure 508a is set to 1, the packet validity check block 516a adds the OFF field's value to the RC field's value to determine whether the block write or block read access operation will cross an aligned 8-dword boundary. If so, the OFF field check fails and the packet validity check block notifies the transfer control block 516b of a malformed packet event.

Once the set of packet validity checks have been performed and the PI-4 packet is determined to be valid, the packet validity check block 516a passes the valid packet to the transfer control block 516b for processing.

If a valid PI-4 packet is identified as a write packet, the transfer control block 516b processes a write command to write data, e.g., extracted from the payload of the received PI-4 packet, to a location in an AS Native Capability Structure 508a specified by an aperture number and address in the received PI-4 packet header.

If the valid PI-4 packet is identified as a read request packet, the transfer control block 516b processes a read request command to retrieve data from a location in the AS Native Capability Structure 508a specified by an aperture number and address in the PI-4 packet header. If a failure occurs before or while the data is being retrieved from the AS Native Capability Structure 508a, the transfer control block 516b generates an AS payload having a PI-4 Read Completion with Error packet header. Within the PI-4 Read Completion with Error packet header, the transfer control block provides a value in a Status Code field that indicates the type of failure that occurred during the data retrieval process. Any partial data that may have been retrieved is typically discarded rather than provided to the remote AS device.

If the data retrieval is successful, the transfer control block 516b generates an AS payload by appending the retrieved data to a PI-4 Read Completion with Data packet header. Within the PI-4 Read Completion with Data packet header, the transfer control block 516b provides a value in the Payload Size field that indicates the size of the retrieved data.

In both cases, the transfer control block 516b generates a PI-4 packet by attaching an AS route header to the AS payload. The generated PI-4 packet is sent to the transmit queue 518, which requests access and transfers the generated PI-4 packet to one of multiple VCs in the AS-Core transmit unit 506. The PI-4 packet is then returned to the remote AS device through the switched fabric network 100.

The invention and all of the functional operations described in this specification can be implemented in digital electronic circuitry, or in computer hardware, firmware, software, or in combinations of them. The invention can be implemented as a computer-program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A method comprising:
receiving a node configuration packet that includes a request for access to a memory space of an Advanced Switching device;
performing a set of checks on a header of the received node configuration packet to determine whether the packet is valid; and
processing the access request when the packet is determined to be valid.

2. The method of claim 1, further comprising:
identifiying one or more header fields of a node configuration packet header to be checked; and
storing one or more expected values for each identified header field.

3. The method of claim 1, wherein performing comprises:
comparing a set of pre-stored expected values with a corresponding set of values provided in the header of the received node configuration packet.

4. The method of claim 3, wherein the comparisons are performed in parallel in a single clock cycle.

5. The method of claim 3, wherein the comparisons are performed in multiple clock cycles.

6. The method of claim 1, further comprising:
determining that the packet is valid only if the values provided in the header of the received node configuation packet satisy all of the performed checks.

7. The method of claim 1, wherein processing the access request comprises:
retrieving data from an address location in the memory space specified by the access request; and
providing the retrieved data to a source of the request.

8. The method of claim 1, wherein processing the access request comprises:
writing data to an address location in the memory space specified by the access request.

9. An apparatus comprising:
a transaction executor operative to:
receive a node configuration packet that includes a request for access to a memory space of an Advanced Switching device;
perform a set of checks on a header of the received node configuration packet to determine whether the packet is valid; and
process the access request when the packet is determined to be valid.

10. The apparatus of claim 9, wherein the transaction executor is further operative to:
identifiy one or more header fields of a node configuration packet header to be checked; and
store one or more expected values for each identified header field.

11. The apparatus of claim 9, wherein the transaction executor is further operative to:
compare a set of pre-stored expected values with a corresponding set of values provided in the header of the received node configuration packet.

12. The apparatus of claim 11, wherein the transaction executor is operative to perform the comparisons in parallel in a single clock cycle.

13. The apparatus of claim 11, wherein the transaction executor is operative to perform the comparisons in multiple clock cycles.

14. The apparatus of claim 9, wherein the transaction executor is further operative to:
determine that the packet is valid only if the values provided in the header of the received node configuation packet satisy all of the performed checks.

15. The apparatus of claim 9, wherein the transaction executor is further operative to:
retrieve data from an address location in the memory space specified by the access request; and
provide the retrieved data to a source of the request.

16. The apparatus of claim 9, wherein the transaction executor is further operative to:
writie data to an address location in the memory space specified by the access request.

17. An article comprising a machine-readable medium including machine-executable instructions, the instructions to cause the machine to:
receive a node configuration packet that includes a request for access to a memory space of an Advanced Switching device;
perform a set of checks on a header of the received node configuration packet to determine whether the packet is valid; and
process the access request when the packet is determined to be valid.

18. The article of claim 17, further comprising instructions to cause the machine to:
identify one or more header fields of a node configuration packet header to be checked; and
store one or more expected values for each identified header field.

19. The article of claim 17, further comprising instructions to cause the machine to:
compare a set of pre-stored expected values with a corresponding set of values provided in the header of the received node configuration packet.

20. The article of claim 19, further comprising instructions to cause the machine to perform the comparisons in parallel in a single clock cycle.

21. The article of claim 19, further comprising instructions to cause the machine to perform the comparisons in multiple clock cycles.

22. The article of claim 17, further comprising instructions to cause the machine to:
determine that the packet is valid only if the values provided in the header of the received node configuation packet satisy all of the performed checks.

23. The article of claim 17, further comprising instructions to cause the machine to:
retrieve data from an address location in the memory space specified by the access request; and
provide the retrieved data to a source of the request.

24. The article of claim 17, further comprising instructions to cause the machine to:
write data to an address location in the memory space specified by the access request.

25. A system comprising:
a first device that communicates with a second device over an Advanced Switching fabric, the first device capable of:
receiving a node configuration packet that includes a request for access to a memory space of an Advanced Switching device;
performing a set of checks on a header of the received node configuration packet to determine whether the packet is valid; and
processing the access request when the packet is determined to be valid.

26. The system of claim 25, wherein the first device is further capable of:
identifiying one or more header fields of a node configuration packet header to be checked; and
storing one or more expected values for each identified header field.

27. The system of claim 25, wherein the first device is further capable of:
comparing a set of pre-stored expected values with a corresponding set of values provided in the header of the received node configuration packet.

28. The system of claim 27, wherein the comparisons are performed in parallel in a single clock cycle.

29. The system of claim 27, wherein the comparisons are performed in multiple clock cycles.

30. The system of claim 25, wherein the first device is further capable of:
determining that the packet is valid only if the values provided in the header of the received node configuation packet satisy all of the performed checks.

31. The system of claim 25, wherein the first device is further capable of:
retrieving data from an address location in the memory space specified by the access request; and
providing the retrieved data to a source of the request.

32. The system of claim 25, wherein the first device is further capable of:
writing data to an address location in the memory space specified by the access request.
